(19) United States
(12) Patent Application Publication
(10) Pub. No.: US 2018/0173559 A1
(43) Pub. Date: Jun. 21, 2018

(54) Electronic Control Device and Stack Usage Method

(71) Applicant: Hitachi Automotive Systems, Ltd., Hitachinaka-shi, Ibaraki (JP)

(72) Inventors: Tadayuki MORIKAWA, Isesaki-shi (JP); Akihito KUBOTA, Isesaki-shi (JP); Yusuke ABE, Isesaki-shi (JP); Teruaki TAKAGI, Isesaki-shi (JP)

(21) Appl. No.: 15/738,319

(22) PCT Filed: Jun. 30, 2016
(86) PCT No.: PCT/JP2016/069511

§ 371 Date: Dec. 20, 2017

(30) Foreign Application Priority Data
Jul. 1, 2015 (JP) 2015-132780

(51) Int. Cl. G06F 9/48; G06F 9/50

(52) U.S. Cl. CPC G06F 9/4812; F02D 45/00; G06F 9/5038

(57) ABSTRACT

The electronic control device includes a memory and a processor. The processor is configured to use, in executing a task, at least one stack region for the task, which is previously allocated to the task, out of a plurality of stack regions allocated in the memory.

### TECHNICAL FIELD

The present invention relates to an electronic control device using a stack region and a stack usage method.

### BACKGROUND ART

In electronic control devices, a RAM (Random Access Memory) is partially used as a stack region. This stack region is used for temporarily saving data being processed, etc. in the electronic control device (see, for example, Patent Document 1).

### REFERENCE DOCUMENT LIST

### Patent Document

Patent Document 1: JP 2008-184912 A

### SUMMARY OF THE INVENTION

### Problems to be Solved by the Invention

The ISO (International Organization for Standardization) 26262 defines standards for vehicle functional safety. A safety level called an ASIL (Automotive Safety Integrity Level) is assessed based on the above standards. The safety level is classified in five levels: ASIL-D, ASIL-C, ASIL-B, ASIL-A, and QM ranked by safety standards. In ensuring the above functional safety, for example, each task is assigned a safety level and it is necessary to protect a task of a higher safety level against any influence of a task of a lower safety level.

Thus, the electronic control device has to prevent a task of a lower safety level (for example, QM) from accessing stack data temporarily saved in a stack region in relation to a task of a higher safety level (for example, ASIL-D).

It is accordingly an object of the present invention to provide an electronic control device and a stack usage method, which can more strictly restrict accesses to stack data.

### Means for Solving the Problems

In order to achieve the above object, an electronic control device includes a memory and a processor, the processor using, in executing a task, at least one stack region for the task, which is previously allocated to the task, out of a plurality of stack regions allocated in the memory.

### Effects of the Invention

According to the electronic control device, accesses to stack data can be more strictly restricted, whereby functional safety is ensured.

### BRIEF DESCRIPTION OF THE DRAWINGS

FIG. 1 is a block diagram illustrating an embodiment of an electronic control device.

FIG. 2 illustrates the configuration of a stack region of the electronic control device.

FIG. 3 illustrates the configuration of a stack region of the electronic control device.

FIG. 4 illustrates a flow when the electronic control device executes a task.

FIG. 5 illustrates a flow when the electronic control device executes a task to monitor usage of a stack region.

FIG. 6 illustrates timing at which the electronic control device monitors usage of a stack region.

### MODE FOR CARRYING OUT THE INVENTION

Hereinafter, embodiments of the present invention will be described with reference to the accompanying drawings.

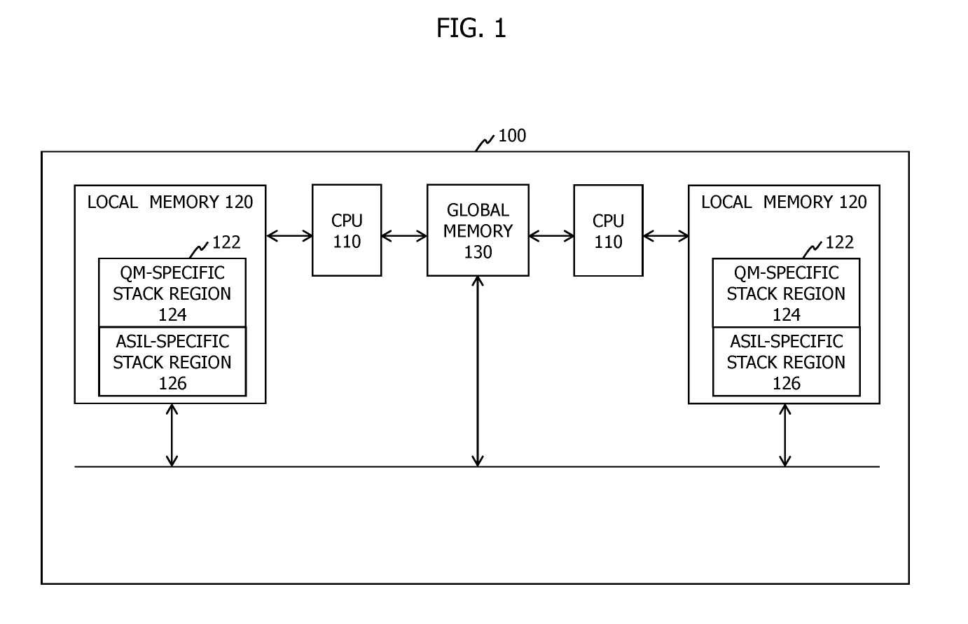

FIG. 1 illustrates an embodiment of an in-vehicle electronic control device 100. Electronic control device 100 executes various types of control over a vehicle. For example, electronic control device 100 controls an internal combustion engine. Electronic control device 100 includes plural CPUs (Central Processing Units) 110, plural local memories 120, and a global memory 130.

CPU 110 can read detection values, etc. from various sensors connected to electronic control device 100 to calculate target values for vehicle control. Specifically, CPU 110 receives signals from various sensors, etc. such as a crank angle sensor, a cam angle sensor, a water temperature sensor, a throttle sensor, an air flow sensor, and an air-fuel ratio sensor although not illustrated. Then, CPU 110 calculates data necessary for various types of control on an electronic control throttle valve, a fuel injector, and a spark coil, referring to a control map, for example.

Each CPU 110 is connected to local memory 120 provided in each CPU 110 and global memory 130. All CPUs 110 can access global memory 130. Local memories 120 are provided in CPUs 110 in a one-to-one correspondence and used to only execute a corresponding CPU 110. Local memory 120 includes a stack region 122 and any other types of memory regions to save data in an LIFO (Last In First Out) method.

Electronic control device 100 has plural modes with different limitations of access to the stack region in executing a task. The access limitations are determined according to the level defined by the safety standards. In this embodiment, the plural modes include a supervisor mode (SVM) and a user mode (UM). By setting an access authority for each mode, the access limitations are enabled. In the SVM, a task of a safety level ASIL-D, C, B, or A is executed, whereas in the UM, a task of a safety level QM is executed. In other words, in electronic control device 100, tasks are classified into groups based on a predetermined rule such as the safety level so that a task can be executed in a mode corresponding to a group to which the task belongs.

Stack region 122 provided in local memory 120 is divided into two regions: a QM-specific stack region 124 and an ASIL-specific stack region 126. That is, local memory 120 ensures two stack regions. A UM-based task can only access QM-specific stack region 124 and cannot access ASIL-specific stack region 126. An SVM-based task can access ASIL-specific stack region 126 and QM-specific stack region 124. Such access limitations for each task can be realized by hardware such as a memory management unit. Note that this embodiment focuses on three types of accesses, i.e., “read”, “write”, and “execute”. These accesses are collectively allowed or disallowed. However, it is also possible to allow some of the accesses, like disallowing “write” and “execute” and allowing “read”, for example. Also, in each mode, whether to disallow or allow an access can be determined for each stack region and access type.

Note that in this embodiment, two stack regions are allocated in local memory 120, but electronic control device 100 can ensure three or more stack regions in local memory 120.

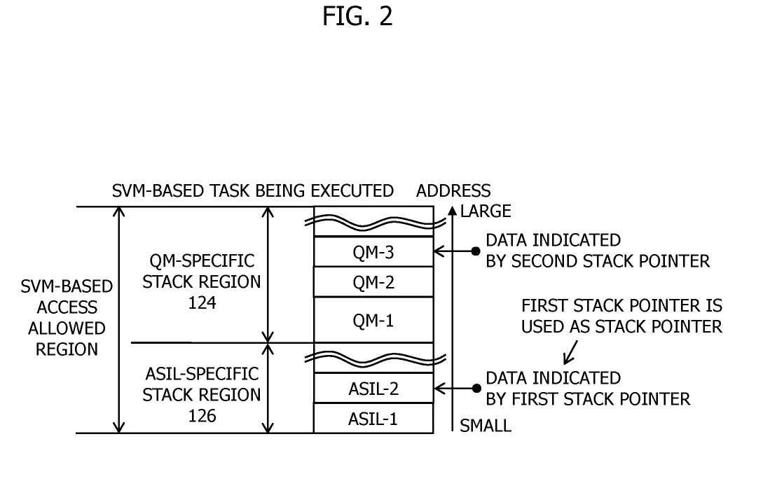

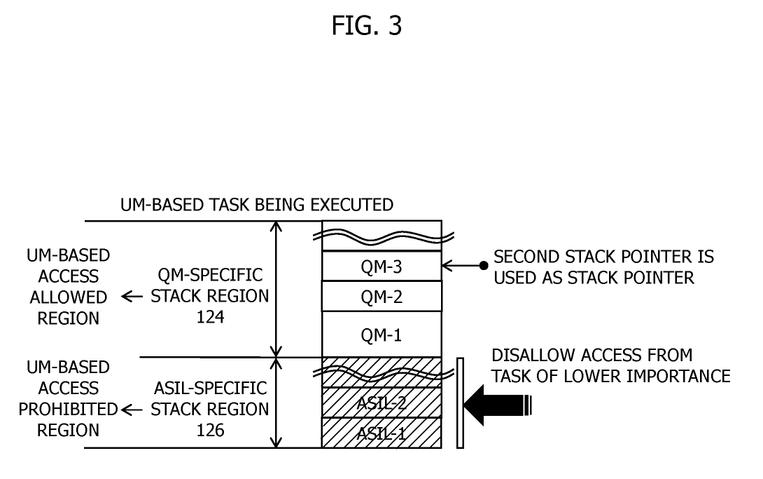

Referring next to FIGS. 2 and 3, stack region 122 is described in detail.

In stack region 122, data is stored in the direction of increasing an address, for example. In FIGS. 2 and 3, the address value increases in the upper direction. In stack region 122, memory regions are allocated, in order of increasing an address, to ASIL-specific stack region 126 and QM-specific stack region 124 in this order. To be specific, stack region 122 has a stack region of lower importance on the side where data is stored. In other words, each stack region 122 is configured so that the divided stack regions are assigned in the direction in which stack data is stored, in order of decreasing importance.

Also, as illustrated in FIG. 2, in stack region 122, a first stack pointer indicating data ASIL-2, i.e., the most recently added data in ASIL-specific stack region 126 and a second stack pointer indicating data QM-3, i.e., the most recently added data in QM-specific stack region 124 can be switched according to the mode. FIG. 2 illustrates how the SVM-based task is executed. In this case, electronic control device 100 can arbitrarily switch the first and second stack pointers for use. During the execution of the SVM-based task, accesses to QM-specific stack region 124 and ASIL-specific stack region 126 are allowed. FIG. 3 illustrates how the UM-based task is executed. In this case, electronic control device 100 uses only the second stack pointer. During the execution of the UM-based task, accesses to ASIL-specific stack region 126 are disallowed.

As mentioned above, when CPU 110 executes a task in electronic control device 100, at least one of the plural stack regions allocated in local memory 120 is selected as a stack region for use by the task. Furthermore, at least one stack region for use by a task is set for each group to which tasks are classified based on a predetermined rule such as the safety level. With the above settings, electronic control device 100 achieves functional safety.

Also, tasks to be executed by electronic control device 100 thus configured are set not to change their modes from an assigned mode to a mode of higher authority. For example, the UM-based task is disallowed to change its mode from the UM to the SVM.

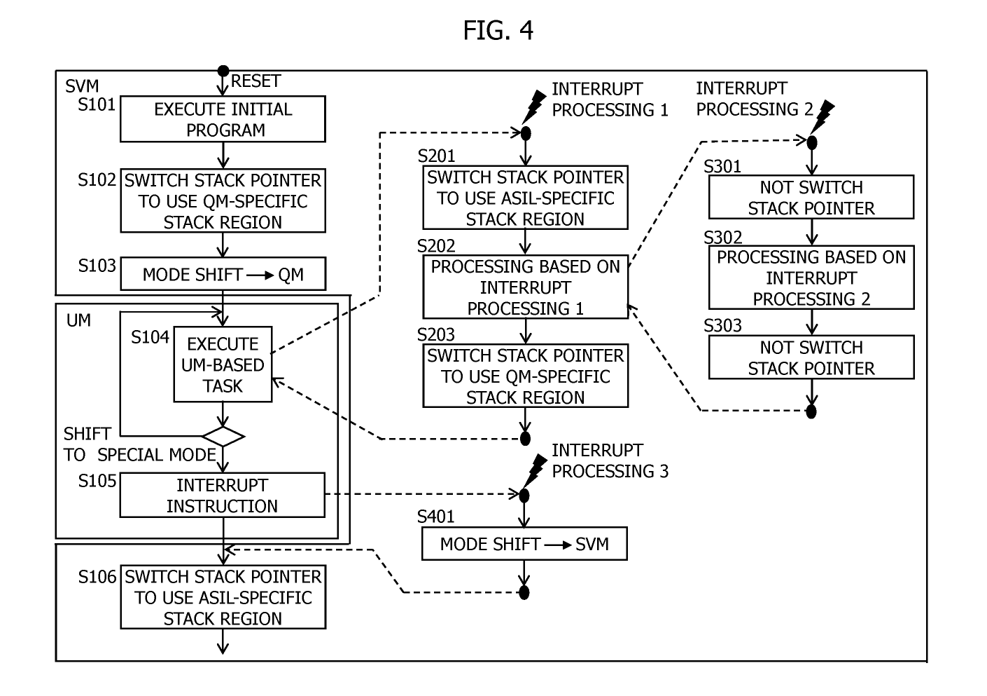

Referring to FIG. 4, a flow of executing a task with electronic control device 100 is described below.

First, at the beginning of this flow, the mode is set to the SVM. As the flow starts with the SVM, electronic control device 100 uses the first stack pointer indicating the most recently added data in ASIL-specific stack region 126 at this time. Then, electronic control device 100 executes an initial program (S101).

Next, in executing the program, electronic control device 100 may execute a UM-based task, and if executed, the mode is switched from the SVM to the UM. At this time, electronic control device 100 first switches the stack pointer to the second stack pointer indicating the most recently added data in QM-specific stack region 124 (S102). Then, electronic control device 100 switches the mode from the SVM to the UM (S103).

After the mode shift to the UM, electronic control device 100 executes the UM-based task and at this time, uses QM-specific stack region 124 as a stack region (S104).

For example, the UM-based task can be a target torque calculation task. This task is to calculate a target torque from an accelerator opening and calculate a target throttle opening of an electronic control throttle valve based on the target torque. A description is given below of an example of executing the target torque calculation task.

In the target torque calculation task, electronic control device 100 first reads an output related to an accelerator opening, from an accelerator pedal sensor. Also, electronic control device 100 calculates a target torque from the accelerator opening. Then, electronic control device 100 calculates a target throttle opening so as to obtain the calculated target torque, and controls an electronic control throttle valve based on the target throttle opening.

Next, it is necessary to determine whether any abnormality occurs during the aforementioned control of the electronic control throttle valve. Thus, electronic control device 100 calculates a current torque aside from the target torque and compares the current torque with the target torque to determine whether any abnormality occurs. Here, a task to implement such determination is given a higher safety level than QM (for example, ASIL-C). Hereby, this task cannot be executed in the UM and has to be executed in the SVM. Then, electronic control device 100 issues an interrupt instruction to interrupt the current task by an SVM-based abnormality detection task (interrupt processing 1) so as to determine whether a failure occurs.

Regarding interrupt processing 1, since the abnormality detection task is executed in the SVM, electronic control device 100 first has to use the first stack pointer indicating the data in ASIL-specific stack region 126. In this embodiment, the UM-based task is executed and the second stack pointer is used before the interrupt processing, and thus electronic control device 100 switches the stack pointer to the first stack pointer so that ASIL-specific stack region 126 can be used as its stack region (S201). Next, electronic control device 100 calculates a current torque based on outputs from various sensors. Then, electronic control device 100 compares the target torque with the current torque to determine whether any abnormality occurs (S202).

Aside from the above abnormality determination, electronic control device 100 determines whether a failure occurs in relation to the order of executing tasks or execution timing, and executes a task to handle the abnormality. This task is given a higher safety level than QM (for example, ASIL-C) and thus, has to be executed in the SVM. Then, if it is necessary to perform the above abnormality determination as to a functional operation during the processing in S202 of interrupt processing 1, electronic control device 100 further executes an interrupt processing 2 as a task to determine whether a failure occurs in the functional operation. As this functional operation abnormality determination task is executed in the SVM, electronic control device 100 first determines whether the first stack pointer is used. In this embodiment, since the abnormality determination as to the functional operation is performed during interrupt processing 1, the first stack pointer has been already used and ASIL-specific stack region 126 is usable as its stack region. Hence, electronic control device 100 does not switch the stack pointer (S301). Then, electronic control device 100 executes the functional operation abnormality determination task (S302). After the completion of the functional operation abnormality determination task, electronic control device 100 will return to the processing in the SVM. Thus, electronic control device 100 returns to interrupt processing 1 without switching the stack pointer from the first stack pointer (S303).

Electronic control device 100 resumes interrupt processing 1. After the completion of interrupt processing 1, electronic control device 100 will return to the UM-based task. Thus, electronic control device 100 switches the stack pointer to the second stack pointer, and uses only QM-specific stack region 124 as its stack region (S203). After that, electronic control device 100 resumes the target torque calculation task.

Here, according to circumstances, it is necessary to shift the mode to a special mode such as a program rewrite mode during the control by electronic control device 100, and thus the mode may be shifted from the UM to the SVM of higher importance. However, in electronic control device 100, the UM-based task cannot shift its mode from the QM to the SVM. Here, in this embodiment, the mode shift from a mode of lower importance to a mode of higher importance is enabled by an interrupt processing that is to interrupt the current task by the SVM-based task. Specifically, electronic control device 100 issues an interrupt instruction (S105) to thereby interrupt the current task by the SVM-based task and shift the mode from the UM to the SVM (S401). After the mode shift, the SVM-based task switches the stack pointer to the first stack pointer so that ASIL-specific stack region 126 can be used as its stack region during the processing (S106). In this step, electronic control device 100 executes processing, etc. in a special mode.

As mentioned above, electronic control device 100 executes an interrupt processing according to a task to be executed, on the condition that plural stack regions are allocated, and appropriately switches the stack pointers and the stack regions to execute a program.

Here, when a task is executed on the condition that that plural stack regions are allocated, electronic control device 100 can monitor whether a stack region is properly used according to a group to which the task belongs.

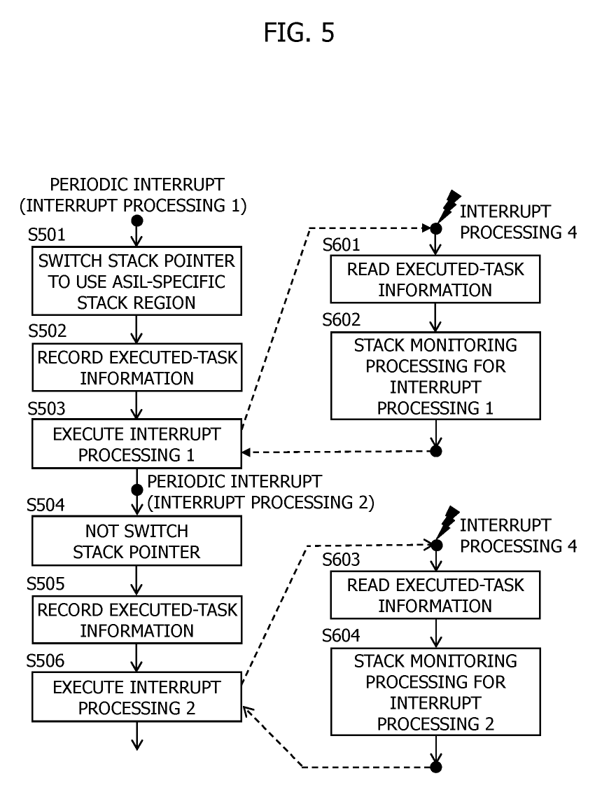

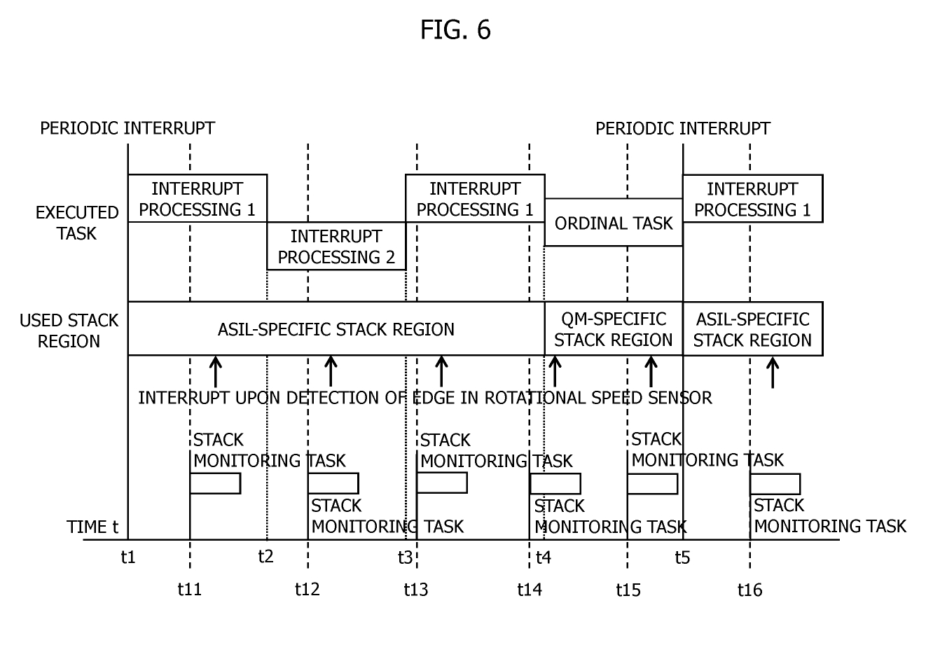

The above task for monitoring is executed in an interrupt processing. Referring to FIGS. 5 and 6, the interrupt processing is described.

FIG. 5 is a conceptual diagram illustrating how a task to monitor whether a stack region is properly used (interrupt processing 4) is executed as an additional interrupt processing in the flow of executing interrupt processing 1 and interrupt processing 2. Note that interrupt processings 1 and 2 are executed as periodic interrupts.

The flow of FIG. 5 starts with the onset of the interrupt processing 1 as periodic interrupt. Interrupt processing 1 being executed, electronic control device 100 switches the stack pointer to the first stack pointer and executes the processing using ASIL-specific stack region 126 as its stack region (S501). Then, electronic control device 100 records executed-task information indicating a task to be executed, in a suitable memory before the task is executed (S502). After that, electronic control device 100 executes interrupt processing 1 (S503).

In this case, during the execution of interrupt processing 1, interrupt processing 4 is executed, which is to monitor whether a task being executed uses a stack region that has been previously allocated according to a group to which the task belongs, at timing not correlated with timing of periodic interrupt. In this embodiment, electronic control device 100 executes interrupt processing 4 at timing at which a rising edge and a falling edge are detected in an engine rotational speed sensor such as a crank angle sensor.

In interrupt processing 4, electronic control device 100 refers to a table that associates a task belonging to a group with a stack region previously allocated to the group and intended for use by the task in the group, so as to monitor whether a task being executing in interrupt processing 1 uses a stack region previously allocated to a group to which the task belongs.

For example, electronic control device 100 first reads executed-task information (S601). Then, electronic control device 100 refers to a table that associates, for each group, a task belonging to a group and an address range of a stack region previously allocated to the group. Also, electronic control device 100 reads, for a group related to the executed-task information, an address range of a stack region previously allocated to the group, from the table. Then, if the stack pointer indicates the thus-read previously allocated address range, electronic control device 100 determines that the executed task uses a stack region previously allocated to the group to which the executed task belongs. On the other hand, if the stack pointer indicates a region outside of the thus-read previously allocated address range, electronic control device 100 determines that the executed task does not use a stack region previously allocated to a group to which the executed task belongs. Then, if electronic control device 100 determines that the executed task uses a stack region previously allocated to a group to which the executed task belongs, it terminates the interrupt and returns to the original processing. On the other hand, if electronic control device 100 determines that the executed task does not use a stack region previously allocated to the group to which the executed task belongs, it notifies any external device of an error or records the error in an unillustrated non-volatile memory (flash memory, etc.), for example (S602).

Next, after the completion of interrupt processing 4 for stack monitoring, electronic control device 100 returns to interrupt processing 1. As described above, electronic control device 100 subsequently executes, as periodic interrupt, interrupt processing 2 that is a functional operation abnormality determination task during the execution of interrupt processing 1. Interrupt processing 2 is an SVM-based task and uses ASIL-specific stack region 126 as its stack region. Since the first stack pointer has been used in interrupt processing 1, electronic control device 100 does not switch the stack pointer (S504). As in S502, electronic control device 100 records executed-task information about interrupt processing 2 (S505) like S502. After that, electronic control device 100 executes interrupt processing 2.

In this case, during the execution of interrupt processing 2, electronic control device 100 detects an edge in the engine rotational speed sensor, for example, to execute interrupt processing 4 for stack monitoring. In interrupt processing 4, electronic control device 100 reads executed-task information (S603). Electronic control device 100 determines, based on the read executed-task information, whether an executed task uses a stack region previously allocated to a group to which the executed task belongs and then, performs the same processing as in S602 (S604). After that, electronic control device 100 terminates interrupt processing 4 and returns to interrupt processing 2.

Referring to FIG. 6, a description is given of a relationship among the time, an executed task, a stack region to be used, and timing of executing a stack monitoring task in the aforementioned task monitoring example.

First, a relationship between the executed task and a stack region for use by the task is described. At time t1, interrupt processing 1 as periodic interrupt is executed. In this case, ASIL-specific stack region 126 is used as the stack region. Next, interrupt processing 2 is executed at time t2. In this case, ASIL-specific stack region 126 is used as the stack region similar to interrupt processing 1. Then, interrupt processing 2 is terminated at time t3, and interrupt processing 1 is resumed. Furthermore, interrupt processing 1 is terminated at time t4, and an ordinal task is resumed. At this time, the stack pointer is switched indicating QM-specific stack region 124. Next, interrupt processing 1 is executed as periodic interrupt during the execution of the ordinal task at time t5. In response, the stack monitoring task generates an interrupt when the edge is detected in the engine rotational speed sensor (t11 to t16) so as to execute the stack monitoring task. Here, the timing of detecting the edge in the engine rotational speed sensor is not correlated with the timing of interrupting the current processing by interrupt processing 1 and interrupt processing 2 as periodic interrupts. By executing the stack monitoring task at the timing of detecting the edge in the engine rotational speed sensor, which is not correlated to the timing of periodic interrupt in this way, it is possible to monitor the usage of a stack region at random timing, not periodic timing.

Note that in this specification, a dual processor composed of two CPUs 110 is described. However, the stack region according to the embodiment is also applicable to a multiprocessor composed of three or more CPUs 110 each having local memory 120. Furthermore, in the case that a local memory is connected for each core in a multi-core processor, the stack region according to the embodiment can be provided in each local memory.

In the embodiment, processing is executed in either of two modes classified by importance. However, electronic control device 100 may have three or more levels of importance so that the number of modes is set according to the number of importance levels, while plural stack regions are ensured.

The term “periodic” in this specification means not only a predetermined time interval but also predetermined timing in a predetermined sequence.

### REFERENCE SYMBOL LIST

100 electronic control device

120 local memory

122 stack region

1-15. (canceled)

16. An electronic control device comprising a memory and a processor,
the processor being configured to use, in executing a task, at least one stack region for the task, which is previously allocated to the task, out of a plurality of stack regions allocated in the memory, as well as configured to execute a stack monitoring task to monitor usage of the stack region at timing of detecting an edge in an engine rotational speed sensor.

17. The electronic control device according to claim 16, wherein the at least one stack region used by the task is set for each group to which tasks are classified based on a predetermined rule.

18. The electronic control device according to claim 16, wherein the processor is a multi-core processor and the memory is connected for each core.

19. The electronic control device according to claim 16, wherein the processor is configured to switch a pointer indicating an address of each stack region in the memory so as to use the at least one stack region previously allocated to the task.

20. The electronic control device according to claim 16, wherein a plurality of levels are set for the task according to a safety level, and
the processor is configured to select the at least one stack region according to a level of the task.

21. The electronic control device according to claim 20, wherein the processor is configured, when executing the task, to disallow usage of at least one stack region previously allocated to a task of higher level than the task.

22. The electronic control device according to claim 20, wherein the processor is configured, when executing a task of higher level than a task being executed, to generate an interrupt processing to execute the task.

23. The electronic control device according to claim 16, wherein the stack regions are classified by level of functional safety of a vehicle.

24. A stack usage method in which when executing a task, a processor of an electronic control device uses at least one stack region for the task, which is previously allocated to the task, out of a plurality of stack regions allocated in a memory, as well as executes a stack monitoring task to monitor usage of the stack region at timing of detecting an edge in an engine rotational speed sensor.

25. The stack usage method according to claim 24, wherein the at least one stack region used by the task is set for each group to which tasks are classified based on a predetermined rule.

26. The stack usage method according to claim 24, wherein the processor switches a pointer indicating an address of each stack region in the memory so as to use the at least one stack region previously allocated to the task.

27. The stack usage method according to claim 24, wherein a plurality of levels are set for the task according to a safety level, and
the processor selects the at least one stack region according to a level of the task.

28. The stack usage method according to claim 27, wherein when executing the task, the processor disallows usage of at least one stack region previously allocated to a task of higher level than the task.

29. The stack usage method according to claim 27, wherein when executing a task of higher level than a task being executed, the processor generates an interrupt processing to execute the task.

30. The stack usage method according to claim 24, wherein the stack regions are classified by level of functional safety of a vehicle.
